(19) United States
(12) Patent Application Publication
(10) Pub. No.: US 2013/0077147 A1
(43) Pub. Date: Mar. 28, 2013

(54) Method for producing a partially coherent beam with fast pattern update rates

(71) Applicant: Anatoly V. Efimov, Los Alamos, NM (US)

(72) Inventor: Anatoly V. Efimov, Los Alamos, NM (US)

(73) Assignee: LOS ALAMOS NATIONAL SECURITY, LLC, Los Alamos, NM (US)

(21) Appl. No.: 13/241,021

(22) Filed: Sep. 22, 2011

(51) Int. Cl. G02F 1/01; G02F 1/295

(52) U.S. Cl. 359/241; 359/298

(57) ABSTRACT

A method and an apparatus for producing a partially coherent optical beam with a fast update rate are based on scanning a focused input beam across the input end of a multimode optical waveguide. The update rate of the partially coherent optical beam produced at the output of the multimode optical waveguide is increased with respect of the input beam scanning rate by a factor approximately equal to the ratio of the core size of the multimode optical waveguide to the focal spot diameter of the input optical beam. The apparatus may include an angular optical beam deflector based on an electrooptic material such as potassium tantalate niobate (KTN) crystal.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates to producing partially coherent optical beams with fast update rates and the methods for speckle reduction, removal or averaging, also known as de-speckling.

### BACKGROUND OF THE INVENTION

Partially coherent optical beams can be beneficial to a number of applications including optical imaging, optical inspection, lithography, machine vision, remote sensing and free-space optical communication. Partially coherent optical beams are understood to have a property of a temporally fluctuating, spatially-dependent phase and/or amplitude.

An example of a partially coherent optical beam is a light beam from an incandescent light bulb viewed from a distance. For such a light beam, the phase and amplitude of the electromagnetic field fluctuate across the cross section of the light beam with a characteristic correlation time that is equal to the inverse spectral bandwidth of the light beam. Because the spectral bandwidth of the light beam (or equivalently the update rate of the partially coherent optical beam) is very large, the eye (or some other detector) observing the light beam effectively averages the ultrafast fluctuations of the amplitude. In contrast, a fully coherent light beam (e.g. a light beam emitted by a helium-neon laser) does not have a rapidly fluctuating spatial phase and amplitude, and therefore we would see a speckled pattern when we view such a light beam.

Although the light beam emitted from an incandescent bulb (or from another extended light beam source with low spatial coherence) has favorable properties, its use is not always convenient or possible. Oftentimes, it would be beneficial to start with a laser beam and reduce its spatial coherence, thereby generating a partially coherent optical beam. Some reasons for using a laser to generate a partially coherent optical beam are: (1) lasers are energy efficient, (2) lasers may produce high power from a small package, (3) lasers are spectrally narrowband, and (4) lasers can be modulated at gigahertz rates.

One example for which partially coherent optical beams can bring substantial benefits is in free space optical communication. Theoretical and experimental investigations indicate that the use of a partially coherent optical beam in such free space optical communication systems may reduce the deleterious effects of atmospheric turbulence, such as scintillations. Although low spatially coherent sources (e.g. light-emitting diodes) may not be used directly because of their low modulation rates, single-mode lasers and external modulators can easily produce data streams at tens of gigabits per second. After the data stream is produced, the fully coherent single-mode laser signal would need to be converted to a partially coherent optical beam before transmission through the atmosphere.

Another example for which partially coherent optical beams can bring substantial benefit is in laser image projection. A fully coherent laser beam projected on a microscopically rough screen will produce a speckle structure which will degrade the quality of the image. A partially coherent beam, on the other hand, will not degrade the quality of the image because the speckles are effectively averaged, provided the update rate of the partially coherent beam is faster than the integration time of the detector, such as human eye, used to view the projected image. Thus, partially coherent beams are beneficial for speckle removal, also known as de-speckling, in a laser projection applications.

Yet another example in which partially coherent optical beams can bring substantial benefit is in object illumination in optical imaging and lithography applications. Illumination of an object or a lithography mask with a fully coherent optical beam will result in a speckled image, characterized by random spatial intensity fluctuations, which is an unwanted feature in these applications. On the other hand, partially coherent beam will produce smooth image, devoid of speckle structure.

A fully coherent optical beam (e.g. a laser beam) may be converted into a partially coherent optical beam using spinning phase disks or electronically addressable spatial light modulators. The update rates possible with spinning phase disks or electronically addressable spatial light modulators are limited to several kilohertz. These update rates are too slow for practical applications. Furthermore any mechanical motion within the apparatus performing the coherence conversion will severely shorten its lifetime and degrade its reliability. Thus, the production of partially coherent optical beams with faster update rates using non-mechanical means is desirable.

Therefore, an object of this invention is to provide a method and an apparatus for producing partially coherent optical beams with faster update rates.

### SUMMARY OF THE INVENTION

To achieve the foregoing and other objects, and in accordance with the purposes of the present invention, as embodied and broadly described herein, the present invention provides a method and an apparatus for producing a partially coherent beam with fast update rate. The fast update rate may be on the order of a gigahertz or more. According to the method, an input optical beam is sent through an angular optical beam deflector that imparts a time-dependent angular deflection to the input optical beam. The deflected beam is sent through an optical system, such as a lens, that converts the angular deflection of the beam into a spatial, transverse motion and also focuses the beam onto the input end of the core of a multimode optical waveguide, such as a multimode optical fiber. The diameter of the focal spot of the focused optical beam is much smaller than the size of the waveguide core. The focused beam excites a plurality of high-order modes of the multimode optical waveguide. These high-order modes intermix as the beam propagates through the core of the multimode optical waveguide, which results in the beam having a spatially non-uniform intensity and phase distribution at the output end of the multimode optical waveguide. The focus of the input optical beam is scanned across the input end of the multimode optical waveguide in a random or predetermined pattern. The scanning may be in one or two transverse directions. This scanning of the focused input beam across the input end of the multimode optical waveguide leads to continuous changes of the spatially non-uniform intensity and phase distributions of the light beam at the output end of the waveguide, which results in a partially coherent optical beam at the output end of the waveguide. This partially coherent optical beam has a fast update rate (UR). The value of the update rate (UR) is approximately equal to the scanning rate (SR) of the optical beam across the input end of the multimode optical 100 waveguide multiplied by the ratio of the core size (D) to the focal spot diameter (d), i.e. UR SR×Dd⁻¹.

The invention also includes a method for producing a partially coherent beam with a fast update rate. The method includes:

imparting a time-dependent angular deflection to an input optical beam;

converting the time-dependent angular deflection of the input optical beam to a spatial transverse motion while focusing the optical beam into a focal spot onto an input end of a multimode optical waveguide, the waveguide having a core, the core having a predetermined size, the focal spot diameter being no larger than about one tenth the size of the core, and

scanning the optical beam transversely across the input end of the multimode optical waveguide along at least one transverse dimension as the beam passes through the core of the multimode optical waveguide, thereby exciting a plurality of high-order modes of the multimode optical waveguide to create a spatially non-uniform intensity and phase distribution of the optical beam at the output end of the multimode optical waveguide, thus producing a partially coherent optical beam with an update rate that is approximately equal to the time-dependent angle deflection rate multiplied by a ratio of the core size to the focal spot diameter.

The invention is also concerned with an apparatus for producing a partially coherent beam with fast update rate, the apparatus comprising:

an angular optical beam deflector for imparting an angular deflection to an input optical beam, thereby producing an angularly deflected optical beam;

a driver for providing control signals to the angular beam deflector;

an optical system for focusing the angularly deflected optical beam to a focal spot and converting the angular deflection of the angularly deflected optical beam into lateral motion of the focal spot; and

a multimode optical waveguide adapted to intercept the focal spot of the optical beam produced by the optical system.

### BRIEF DESCRIPTION OF THE DRAWINGS

FIG. 1 illustrates an embodiment for producing a partially coherent optical beam with a fast update rate.

FIGS. 2A and 2B show optical intensity distributions produced at the output end of a multimode optical fiber with large and small numerical apertures, respectively.

FIGS. 3A, 3B and 3C show three possible trajectories that a focal spot of a focused optical beam may take across the input face of a multimode optical fiber with circular cross section to produce a partially coherent optical beam with fast update rate.

FIGS. 4A and 4B show a top view and a side view, respectively, of an embodiment for producing a partially coherent optical beam with fast update rate. Two electrooptic crystals are used for scanning a focal spot in two dimensions.

FIG. 5 shows an embodiment for producing a partially coherent optical beam with fast update rate in which a waveplate is inserted between two electrooptic crystals.

### DETAILED DESCRIPTION

A method and an apparatus are provided for generating a partially coherent optical beam with fast update rates (short correlation times). The method involves excitation of a plurality of high-order modes in a multimode optical waveguide by scanning the focal spot of an input optical beam across the input end of the multimode optical waveguide. If the parameters of the system are chosen properly, a large increase in the partially coherent optical beam update rate (UR) with respect to the input beam focal spot scan rate (SR) is possible. The rate increase factor N is approximately equal to the ratio of the multimode optical waveguide core size D to the focal spot diameter d of the focused optical beam.

An embodiment for producing a partially coherent optical beam with a pattern update rate of about 1 GHz (gigahertz) may be achieved by scanning a focal spot with a diameter of about 1 micrometer at a rate of about 1 MHz (megahertz) across the input end of a multimode optical fiber of circular cross section with core diameter of about one millimeter. The rate increase factor N for this embodiment is approximately equal to the ratio of the diameter of the core of the fiber (1 millimeter) to the diameter of the focal spot (1 micrometer).

The invention may be better understood with the accompanying FIGURES. Similar or identical structures are identified using identical callouts.

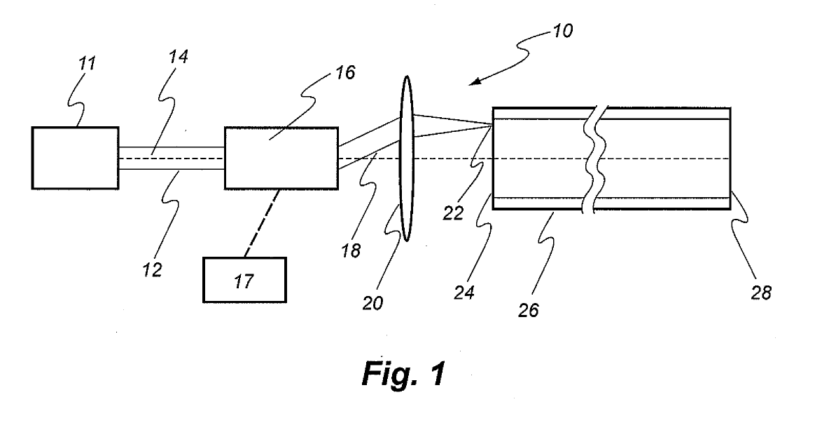

FIG. 1 shows an apparatus 10 including a beam generator 11 for providing a coherent input optical beam 12 propagating along its optical axis 14. Input beam 12 enters an angular optical beam deflector 16. Beam generator 11 may be, for example, a laser, a fiber-based beam generating source such as but not limited to a superluminescent diode, or any other means capable of generating a coherent optical beam of light. Apparatus 10 includes electronic driver 17 for providing control signals to the angular beam deflector 16, which may comprise sinusoidal or other time-dependent voltages. For fast deflecting rates, the angular optical beam deflector 16 may be based on an electrooptic crystal, such as KTN (see, for example: Nakamura et al, “Wide-angle, low-voltage electro-optic beam deflection based on space-charge-controlled mode of electrical conduction in KTa₁₋ₓNbₓO₃,” Appl. Phys. Lett., (2006), vol., 89, pp. 131115-1 through 13115-3, incorporated by reference herein; and Foshee et al., “A Novel High-Speed Electro-Optic Beam Scanner Based on KTN Crystals,” Proc. SPIE, 2007, vol. 6709, pp. 670908-Z, incorporated by reference herein). The KTN-based optical beam deflectors may achieve substantial angular deflections of a collimated optical beam with hundreds of kilohertz scan rates. For slower systems, one may also choose a mechanical scanner such as a galvano scanner or a microelectromechanical system (MEMS). Following the angular optical beam deflector, the angularly-deflected optical beam 18 enters an optical system 20 which converts the angular deflection of the angularly deflected optical beam into a lateral displacement with respect to optical axis 14. Optical system 20 also focuses the optical beam to a focal spot 22 on the input end 24 of multimode optical waveguide 26. In FIG. 1, the optical system 20 is shown as one lens. In other embodiments optical system 20 may comprise multi-component refractive and/or reflective optical elements, such as compound lenses and mirrors. Waveguide 26 may have a transverse cross section of a regular shape such as circular shape, a rectangular shape, a square shape, or an irregular shape. It should be understood that optical system 20 of apparatus 10 may include any combination of lenses and/mirrors that convert the angular deflection of the optical beam into lateral motion while focusing the angularly deflected optical beam into a focal spot at the input end of the multimode optical waveguide 26.

An embodiment subassembly apparatus of this invention includes all of the aforementioned elements shown in FIG. 1 but without beam generator 11.

In an embodiment apparatus 10, multimode optical waveguide 26 is a multimode optical fiber with a circular cross section.

In another embodiment apparatus 10, multimode optical waveguide 26 is a photonic crystal fiber, which may have an irregular shaped cross section.

In still another embodiment apparatus 10, multimode optical waveguide 26 is an integrated photonic chip-scale waveguide, which may have a rectangular cross section.

If the diameter of focal spot 22 is much smaller than the size of the core of multimode optical waveguide 26, which may be multimode optical fiber, many of the modes of the multimode optical waveguide will be excited in the multimode optical waveguide. Due to a difference in phase velocities (propagation vectors or effective indices) the excited modes will acquire different phase delays after their propagation towards the output end 28 of multimode optical waveguide 26. As a result, these modes will produce a complicated interference pattern at the output end of the multimode optical waveguide with a transverse coordinate-dependent amplitude and phase distribution of the electromagnetic field. This distribution is characterized by a coherence length (r_{c}), which is equal to the characteristic width of the spatial correlation function of the electromagnetic field at the output of the waveguide.

It is often desired to obtain the partially coherent optical beam with the smallest coherence length possible. The minimum coherence length (r_{c0}) obtainable at the output of a multimode optical waveguide is determined by its numerical aperture, which is the measure of the angle of the cone of light emanating from the waveguide, provided all of the modes are excited. Equivalently, the numerical aperture characterizes the acceptance angle of the waveguide. The minimum coherence length r_{c0} is known to be inversely proportional to the numerical aperture.

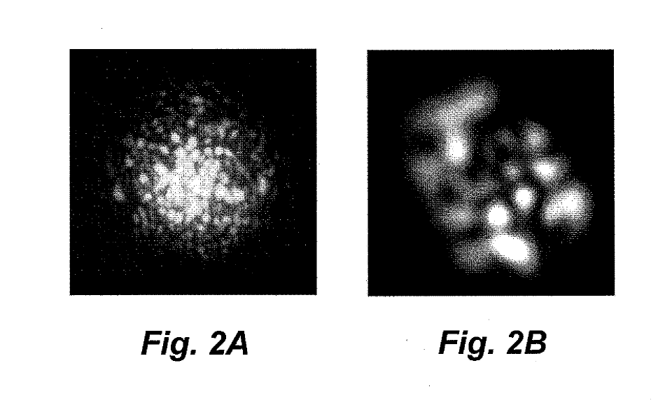

Two examples of light intensity distributions produced by propagating a coherent optical beam through a multimode optical fiber are shown in FIG. 2A and FIG. 2B. These FIGURES show intensity distributions at the output of a multimode optical fiber having a large numerical aperture (FIG. 2A) and a smaller numerical aperture (FIG. 2B). In these figures the characteristic size of the white or dark regions corresponds to the coherence length r_{c} of the light distribution.

In practice the coherence length (r_{c}) at the output end of a multimode optical waveguide depends on the launching conditions of the input beam and also on the length of the waveguide. The coherence length is always larger, or at best, equal to the minimum coherence length: r_{c}≧r_{c0}. The equality occurs when the input optical beam efficiently excites all high-order modes of the waveguide. Excitation of high-order modes of the waveguide is effective when the diameter d of the focal spot of the input optical beam is comparable to the minimum coherence length r_{c0}. Excitation of high-order modes of the multimode optical waveguide will not be effective if the diameter d of the focal spot of the input optical beam is much larger than the minimum coherence length r_{c0} of the multimode optical waveguide.

In an embodiment, the focal spot diameter d of the input beam is on the order of 1-10 micrometers, and is much smaller than the core size D (i.e. d<<D). In an embodiment wherein the focal spot diameter d of the input beam is somewhat larger than the minimum coherence length (r_{c0}) of the multimode optical waveguide, the transverse distribution of the electromagnetic field at the output end of the multimode optical waveguide will be characterized by a coherence length (r_{c}) approximately equal to the focal spot diameter d of the input beam.

If the focal spot of the input beam is stationary on the input end of the multimode optical waveguide, then the electromagnetic field distribution at the output end of the waveguide will also be stationary. However, if the focal spot of the input beam is allowed to move (e.g. scan) across the input end of the multimode optical waveguide, then the output electromagnetic field distribution will continuously vary as the input beam is moved (scanned). The output electromagnetic field distribution will change substantially when the focal spot of the input beam shifts from its initial position by a distance comparable to its focal spot diameter d.

Small shifts of the position of the focal spot of the optical beam on the input end of the multimode optical waveguide result in large changes in output electromagnetic field distribution. For example, if the focal spot of the optical beam traverses the whole core of the multimode optical waveguide, then the output electromagnetic field distribution changes N≈D/d times. This implies a corresponding increase in characteristic rate (update rate) of the output electromagnetic field distribution with respect to the characteristic rate of input beam angular scanning, produced by the optical beam deflector 16 shown in FIG. 1.

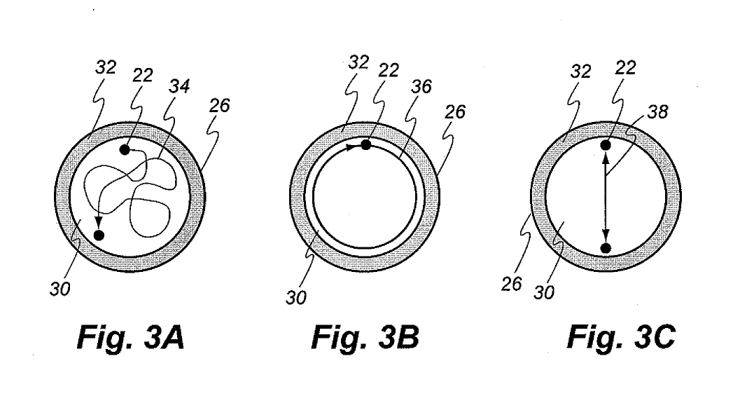

Several non-limiting examples of scanning trajectories of the input beam across the input end of a multimode optical fiber having circular cross section are shown in FIGS. 3A, 313 and 3C. In FIG. 3A the focal spot 22 of the focused optical beam follows a random trajectory 34 on the core 30 of the multimode optical fiber 26. Cladding 32 surrounds the core 30 of the multimode optical fiber 26, as is typical in optical fibers. The use of random trajectory 34 in the embodiment shown in FIG. 3A has benefits because the partially coherent optical beam produced at the output of the multimode optical fiber will not have long-time correlations. However, for practical realization of this situation a 2-dimensional (2D) angular optical beam deflector 16 in FIG. 1 is required. Furthermore, the angular beam deflector 16 and the driver 17, which are shown in FIG. 1, need to support broadband radiofrequency operation.

FIG. 3B shows another embodiment trajectory 36 of the focal spot 22 of the input beam. In this embodiment, the focal spot 22 follows a circular trajectory on the core 30 of the multimode optical fiber. An apparatus for producing this trajectory employs a 2D angular optical beam deflector (16 in FIG. 1) that can be driven sinusoidally, that is at a single radiofrequency, by the driver 17 in FIG. 1, which is often less demanding than drivers that produce broadband control signals.

FIG. 3C shows another embodiment trajectory 38 on the core 30 of the multimode optical fiber that can be achieved with a one-dimensional angular optical beam deflector (16 in FIG. 1). However, long-time correlations in the partially coherent beam generated at the output of the multimode optical fiber will exist for this embodiment.

The axially-symmetric nature of the multimode optical fiber used in the example embodiment described herein is not critical for the performance of the method of the present invention. Multimode optical waveguides of arbitrary cross section geometries may be used equally well according to the present invention.

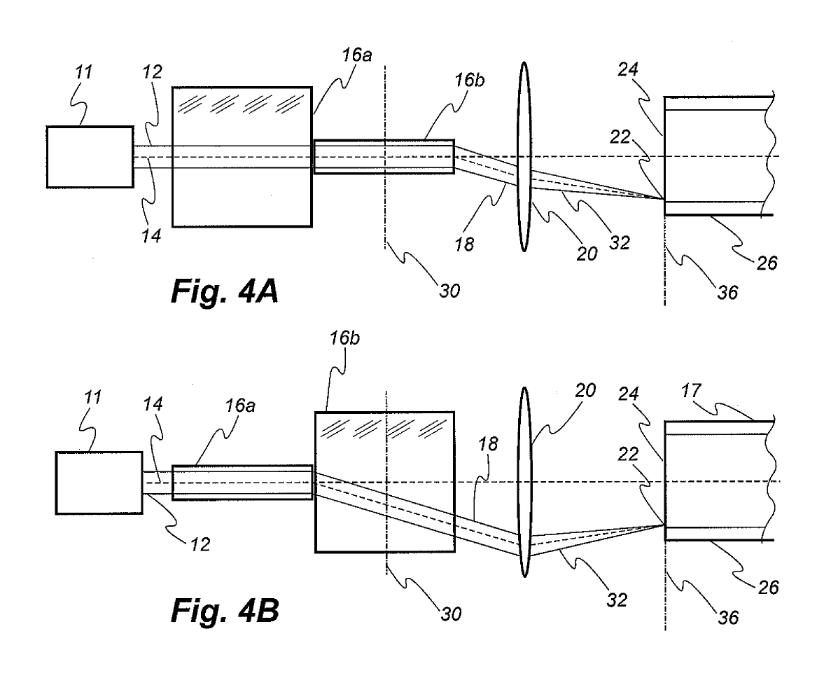

An embodiment employing a 2D angular optical beam deflector featuring two electrooptic crystals, such as KTN, is shown in FIGS. 4A and 4B. These FIGURES show a system featuring two electrooptic crystals 16a and 16b for angular deflection of input optical beam 12 in two dimensions orthogonal to optical axis 14. FIG. 4A shows a view from the top, while FIG. 4B shows a view from the side. The two electrooptic crystals 16a and 16b deflect the input optical beam 12 in two orthogonal planes. Lens 20 is positioned between the multimode optical waveguide 26 and the electrooptic crystals 16a and 16b in such a way that back focal plane 36 coincides with input face 24 of the multimode optical waveguide 26, while the front focal plane 30 is positioned midway between the output surfaces of crystals 16a and 16b. Driving the crystals 16a and 16b by sinusoidal drive signals offset by quarter-period will result in a circular trajectory of the focal spot of the input optical beam, similar to that shown in FIG. 3B. If, however, the crystals 16a and 16b are driven by a random signal, then a random trajectory, similar to the one shown in FIG. 3A will result.

An embodiment subassembly apparatus includes all of the aforementioned elements described and shown in FIGS. 4A and 4B but without beam generator 11.

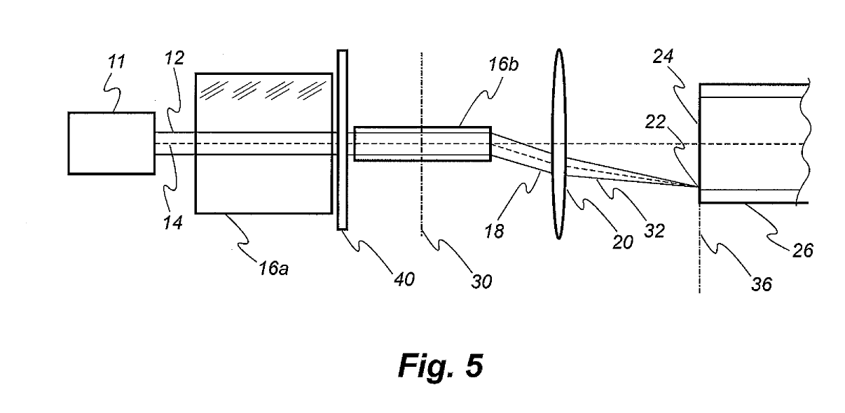

For an embodiment employing a system featuring a two-dimensional angle-scanning device based on electrooptic crystals, such as KTN, the polarization of the input optical beam 12 should be oriented in a certain way with respect to the beam deflection plane. For this embodiment, which is shown in FIG. 5, a λ/2 waveplate 40 would be inserted between the crystals 16a and 16b, as shown in FIG. 5 in order to rotate the polarization by 90 degrees. An embodiment subassembly apparatus includes all of the aforementioned elements described and shown in FIG. 5 without optional beam generator 11.

Although the present invention has been described with reference to specific details, it is not intended that such details should be regarded as limitations upon the scope of the invention, except as and to the extent that they are included in the accompanying claims.

What is claimed is:

1. A method for producing a partially coherent optical beam with fast update rate, the method comprising:
sending an input optical beam through an angular beam deflector that imparts a time-dependent angular deflection on the input optical beam;
sending the optical beam having the time-dependent angular deflection through an optical system that focuses the optical beam and converts the time-dependent angular deflection of the optical beam into a time-dependent spatial, transverse motion;
sending the focused optical beam having the time-dependent transverse motion into a multimode optical waveguide having an input end, and output end, and a core, the core having a predetermined size, the focused optical beam having a focal spot having a diameter that is much smaller than the core size of the multimode optical waveguide, thereby exciting a plurality of high-order modes of the multimode optical waveguide, the high-order modes intermixing while the beam propagates through the multimode optical waveguide to create a spatially non-uniform intensity and phase distribution at the output end of the multimode optical waveguide;
allowing the focal spot of the focused optical beam to move transversely across the input end of the multimode optical waveguide in a random or predefined pattern along one or two transverse dimensions, whereby a continuous change of the spatially non-uniform intensity and phase distribution of the optical beam at the output end of the multimode optical waveguide results, thus producing a partially coherent optical beam with a fast update rate that is approximately equal to the angle-deflection rate multiplied by a ratio of the multimode optical waveguide core size to the optical beam focal spot diameter.

2. The method of claim 1, wherein the input optical beam is a laser beam.

3. The method of claim 1, wherein the angular beam deflector comprises at least one electrooptic crystal.

4. The method of claim 1, wherein the optical system comprises a lens.

5. The method of claim 1, wherein the focal spot diameter of the focused optical beam is no larger than one tenth the core size of the multimode optical waveguide.

6. The method of claim 1, wherein the focal spot diameter of the focused optical beam is from about 1 micrometer to about 10 micrometers.

7. The method of claim 1, wherein the focal spot of the focused optical beam moves transversely across the input end of the multimode optical waveguide at a rate on the order of one hundred kilohertz or higher.

8. The method of claim 1, wherein the multimode optical waveguide comprises a multimode optical fiber.

9. The method of claim 8, wherein the multimode optical fiber is selected from a step-index multimode optical fiber with a circular core no less than 50 micrometers in diameter, a gradient-index multimode optical fiber with a circular core no less than 50 micrometers in diameter, a multimode optical fiber having a noncircular core, a photonic crystal fiber having a non-circular core, a photonic bandgap fiber having an air-filled core, and a multimode optical fiber having an axially non-uniform core.

10. The method of claim 1, wherein the waveguide comprises an integrated optical waveguide having a rectangular core.

11. A method for producing a partially coherent optical beam with fast update rate, comprising:
imparting a time-dependent angular deflection to an input optical beam;
converting the time-dependent angular deflection of the input optical beam to a spatial transverse motion while focusing the optical beam into a focal spot onto an input end of a multimode optical waveguide, the waveguide having a core, the core having a predetermined size, the focal spot diameter being no larger than about one tenth the size of the core, and
scanning the optical beam transversely across the input end of the multimode optical waveguide along at least one transverse dimension as the beam passes through the core of the multimode optical waveguide, thereby exciting a plurality of high-order modes of the multimode optical waveguide to create a spatially non-uniform intensity and phase distribution of the optical beam at the output end of the multimode optical waveguide, thus producing a partially coherent optical beam with an update rate that is approximately equal to the time-dependent angle deflection rate multiplied by a ratio of the core size to the focal spot diameter.

12. The method of claim 11, wherein the input optical beam comprises a laser beam.

13. The method of claim 11, wherein at least one electrooptic crystal is used to impart a time-dependent angular deflection to the input optical beam.

14. The method of claim 11, wherein a lens is used to convert the time-dependent angular deflection of the optical beam to the spatial transverse motion while focusing the optical beam into the focal spot onto the input end of the multimode optical waveguide.

15. The method of claim 11, wherein the focal spot diameter is from about 1 micrometer to about 10 micrometers.

16. The method of claim 11, wherein the focused optical beam is scanned transversely across the input end of the multimode optical waveguide at a rate on the order of one hundred kilohertz or higher.

17. An apparatus for producing a partially coherent beam with fast update rate, the apparatus comprising:
an angular optical beam deflector for imparting an angular deflection to an input optical beam, thereby producing an angularly deflected optical beam;
a driver for providing control signals to the angular beam deflector;
an optical system for focusing the angularly deflected optical beam to a focal spot and converting the angular deflection of the angularly deflected optical beam into lateral motion of the focal spot; and
a multimode optical waveguide adapted to intercept the focal spot of the optical beam produced by the optical system.

18. The apparatus of claim 17, wherein the angular beam-deflecting device comprises at least one electrooptic crystal.

19. The apparatus of claim 17, wherein the optical system comprises a lens.

20. The apparatus of claim 17, wherein the multimode optical waveguide comprises a core size, and wherein the focal spot of the optical beam produced by the optical system is no larger than one tenth the core size of the waveguide.

21. The apparatus of claim 17, wherein a diameter of the focal spot of the focused optical beam produced by the optical system is from about 1 micrometer to about 10 micrometers.

22. The apparatus of claim 17, wherein the angular beam deflector, driver, and optical system are adapted to move the focal spot transversely across the input end of the multimode optical waveguide at a rate of at least one hundred kilohertz.

23. The apparatus of claim 17, further comprising a source for providing the input optical beam.

24. The apparatus of claim 17, wherein the multimode optical waveguide comprises a multimode optical fiber.

25. The apparatus of claim 24, wherein the multimode optical fiber is selected from a step-index multimode optical fiber with a circular core no less than 50 micrometers in diameter, a gradient-index multimode optical fiber with a circular core no less than 50 micrometers in diameter, a multimode optical fiber having a noncircular core, a photonic crystal fiber having a non-circular core, a photonic bandgap fiber having an air-filled core, and a multimode optical fiber having an axially non-uniform core.

26. The apparatus of claim 17, wherein the waveguide comprises an integrated optical waveguide having a rectangular core.
